(19) United States
(12) Patent Application Publication
(10) Pub. No.: US 2026/0065301 A1
(43) Pub. Date: Mar. 5, 2026

(54) AI-Based Real-Time Media Response System for Creator Feedback and Editing Enhancement

(71) Applicant: Nicholas Huang Luo, Danville, CA (US)

(72) Inventor: Nicholas Huang Luo, Danville, CA (US)

(21) Appl. No.: 18/824,906

(22) Filed: Sep. 5, 2024

(51) Int. Cl. G06Q 30/0201; G06F 40/166; G06F 40/253; G06Q 10/067

(52) U.S. Cl. CPC G06Q 30/0201; G06Q 10/067; G06F 40/166; G06F 40/253

(57) ABSTRACT

The invention presents a novel AI-based system for real-time feedback during the creation of various forms of media, including text, audio, and video. The system simulates audience reactions, providing creators with insights into how their content is likely to be perceived by different audience segments. This feedback loop enhances the quality and effectiveness of content, helping creators avoid ambiguity, maintain engagement, and ensure their message resonates with the intended audience.

### FIELD OF INVENTION

This invention relates to the fields of artificial intelligence, natural language processing, and content creation tools. Specifically, it pertains to systems and methods for real-time feedback and analysis during the creation and editing process of various forms of media, including text, audio, and video, providing insights into audience interpretations, emotional responses, and other engagement metrics to enhance communication effectiveness.

### BACKGROUND

For creators, understanding how their media is perceived by audiences during the editing process is invaluable. It allows them to produce content that is clear, engaging, emotionally impactful, and persuasive, while also catering to diverse audiences and market demands. Unintentional wrong perception from audiences can be discovered or avoided before publishing, which otherwise could have been catastrophic in some situations. Real-time feedback empowers creators to refine their work more effectively, resulting in higher quality content that resonates with its intended audience.

Ensuring that media is clear, engaging, and effectively communicates the intended message to diverse audiences involves challenges such as avoiding ambiguity, maintaining interest, and tailoring tone and style to suit various backgrounds and expectations. Creators must balance simplicity with depth, anticipate potential misinterpretations, and address differing levels of knowledge. Additionally, they need to evoke the desired emotional responses while avoiding unintended connotations. These challenges require careful revision and a deep understanding of both the content and the audience.

Existing tools that focus solely on grammar and spell-checking for text, or basic editing tools for audio and video, fall short in offering comprehensive insights into how content is perceived by audiences. These tools are limited to correcting surface-level errors, such as spelling mistakes, grammatical issues, or technical editing, without addressing the nuances of clarity, tone, engagement, or emotional impact. They cannot gauge how effectively a message is conveyed, identify ambiguous or unclear sections, or predict how different audiences might interpret the content. As a result, creators are left without the necessary feedback to refine their work for clarity, audience engagement, and overall effectiveness, missing out on deeper improvements that could enhance the quality and impact of their media.

### SUMMARY OF THE INVENTION

The invention leverages AI to simulate and display audience reactions in real-time as a creator edits text, audio, or video content. The AI analyzes the content to predict audience interpretations, emotional reactions, engagement levels, and expectations.

The system provides feedback on various aspects such as clarity, use of words or visual elements, structure, tone, style, and potential biases, allowing creators to make informed adjustments during the content creation process.

The system can be configured to mimic reactions from different audience types, including experts, general viewers or readers, or audiences with specific political or cultural backgrounds.

### OVERVIEW

The patent presents a novel system and method for enhancing the content creation and editing process through the use of artificial intelligence (AI). This system provides real-time feedback to creators by mimicking audience reactions and interpretations of the media being edited. Key aspects include:
A. AI-Driven Audience Simulation: The system uses AI to generate simulated audience responses, including understanding, engagement levels, emotional reactions (e.g., positive, neutral, negative), and interest levels as the creator edits or produces text, audio, or video content.
B. Real-Time Feedback: During the editing process, the system displays various metrics such as clarity, precision, organization, and style, as well as predictions on what audiences might expect next. It offers insights into how different audience segments (e.g., based on demographics or interests) might perceive the content.
C. Customizable Audience Profiles: The system allows for the configuration of different audience profiles, enabling targeted feedback based on specific audience characteristics or preferences, such as education level, expertise level, or political orientation.
D. Enhancement of Content Quality: By providing detailed feedback on aspects like tone, mood, and emotional impact, the system helps creators identify unclear areas, improve their descriptions, and adjust their content to effectively communicate their intended message to various audiences.
E. Integration with Editing Tools: This AI-powered feedback mechanism can be integrated with existing writing, audio, and video editing tools to offer creators a more comprehensive view of how their work is likely to be received, thereby facilitating clearer and more engaging communication.

### BRIEF DESCRIPTION OF THE DRAWINGS

Embodiments of the invention are disclosed in the following detailed description and accompanying drawings.

FIG. 1 is a function block diagram of a real-time audience response environment in which systems and/or methods described herein may be implemented.

FIG. 2 illustrates an audience profile specifier, which allows the creator to specify what kind of audience the simulated feedback will be from, in accordance with an embodiment of the present invention.

FIG. 3 illustrates how the feedback will be provided to the creator, in accordance with an embodiment of the present invention.

FIG. 4 is a functional flow diagram illustrating how each component of the system works together, in accordance with an embodiment of the present invention.

FIG. 5 illustrates how to obtain a properly trained AI model used in the audience simulation platform

### DESCRIPTION OF EXAMPLE EMBODIMENTS

The following is a description of exemplary embodiments to illustrate the principles of the invention. The embodiments are provided to illustrate aspects of the invention, but the invention is not limited to any embodiment. The scope of the invention encompasses numerous alternatives, modifications, and equivalents; it is limited only by the claims.

Numerous specific details are set forth in the following description to provide a thorough understanding of the invention. However, the invention may be practiced according to the claims without some or all of these specific details. For clarity, technical material that is known in the technical fields related to the invention has not been described in detail so that the invention is not unnecessarily obscured.

Presented here are methods and systems that provide content creators with real-time feedback from simulated audiences of specified types during the process of content creation, so that they can efficiently produce content that meets their goals. For less experienced creators, the feedback can also help discover mistakes or imperfections of many kinds, so that corrections or fine-tuning can be done within a short turn-around time, or even before the first draft is completed.

Creators specify what kind of audience their content is targeted for by giving specifications before they start creating content. Content will be sent to an audience simulation subsystem together with the specification, where a properly trained AI engine will take the inputs and produce simulated audience feedback as output. The feedback is sent back and displayed to the creators, so that they can use the information to edit or modify the content if applicable.

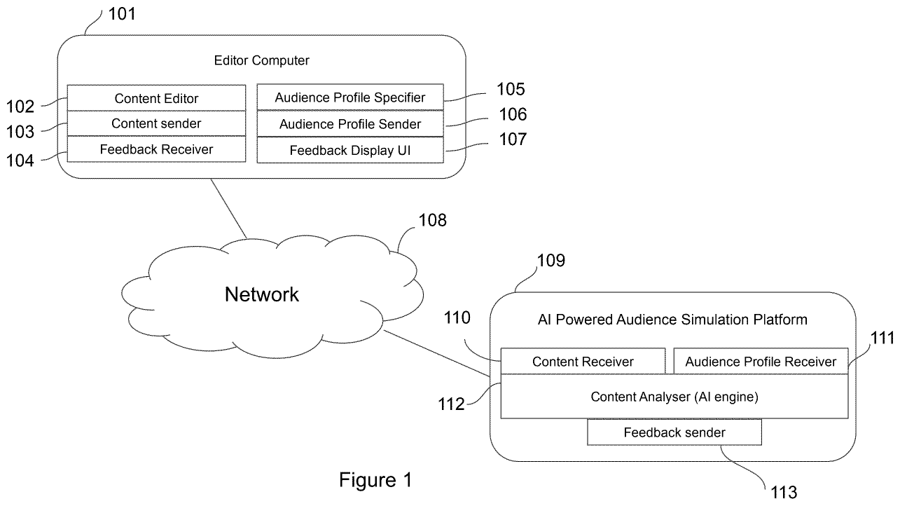

FIG. 1 shows a block diagram of an embodiment of this invention. Creators work with the system through an Editor Computer (101), which can be a personal computer directly running content editing software or a server computer in a data center running such software, and the creators access the software UI through a web browser. Inside the computer, there are multiple components running. Content Editor (102) is for the creator to enter and modify content, e.g., text body of an article, audio track, or video sequence; Audience Profile Specifier (105) is for specifying the type of targeted audience; Content Sender (103) and Audience Profile Sender (106) take data from content editor and audience specifier and send it from the editor computer over computer network (108) to the Audience Simulation Platform (109) where simulated feedback will be generated; Feedback Receiver (104) is to receive feedback data from the Audience Simulation Platform; Feedback Display UI (107) is to visually display the feedback to the creator on the editing computer.

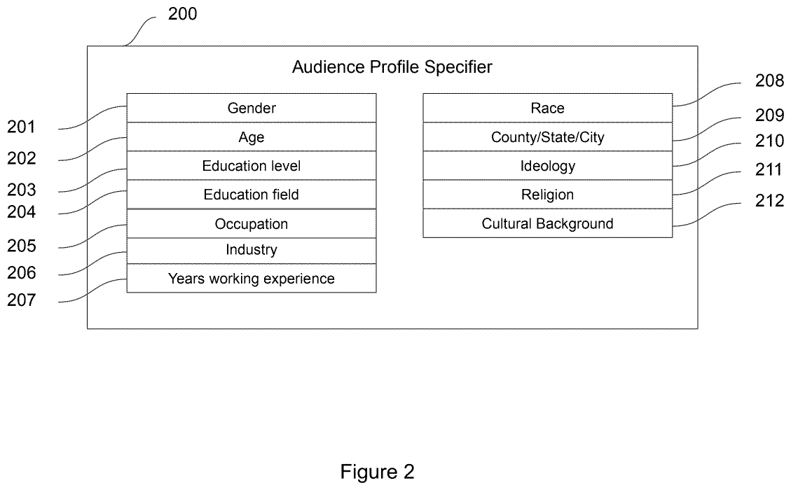

FIG. 2 describes details of the audience profile specifier (200), where the creators enter data depicting what kind of audiences they are creating content for, so that relevant feedback will be received from the system. Example of specification items are audience gender (201), age (202), race (208), education level (203), field or major of college study (204), occupation (205), industry where they work (206), years of working experience (207), residential location (209), ideology (210), religion (211), cultural background (212), etc. Implementations of this invention can include more specification items than the examples here. Together with content to be created, data entered here will be sent over to the audience simulation platform where an AI engine will use it as input to generate results simulating feedback from audiences intentionally targeted.

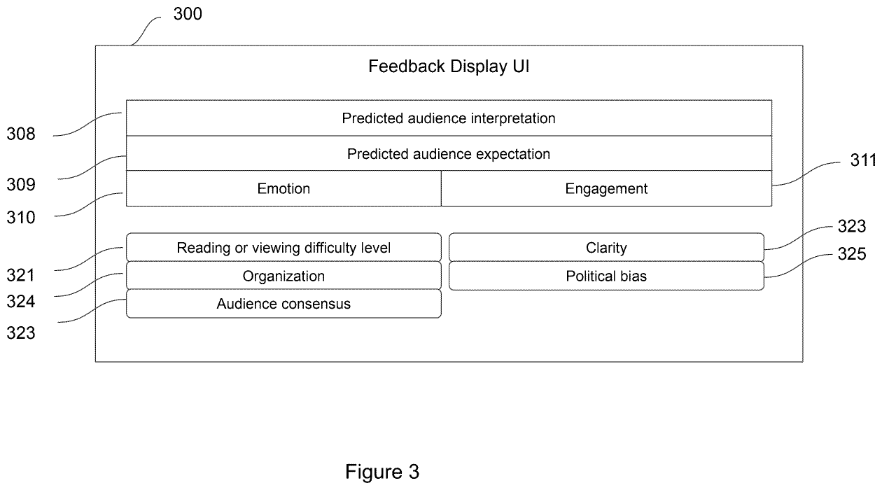

FIG. 3 describes feedback display UI where feedback from the audience simulation platform is displayed to the creator. The example items shown include:
A. Predicted Audience Interpretation (308): This section displays how the simulated target audience is likely to interpret the content. The feedback is expressed in language or visuals that differ from the creator's original content to highlight the audience's perception. This allows the creator to understand potential misinterpretations or areas of ambiguity and adjust accordingly. If the content is unclear or confusing, multiple interpretations might be displayed.
B. Audience Expectation (309): This feedback indicates what the audience expects or predicts for the subsequent portions of the content. For example, if the content is a story, this section might show what the audience anticipates will happen next. Creators can use this information to align their content with or subvert audience expectations to achieve desired effects, whether in storytelling, instruction, or persuasion.
C. Emotion (310): This section reflects the emotional response of the audience to the content. It might show whether the content evokes emotions such as happiness, sadness, anger, excitement, or boredom. This feedback helps the creator gauge whether the content is resonating emotionally as intended.
D. Engagement (311): This metric shows how engaging the audience finds the content. High engagement levels suggest that the audience is interested and absorbed in the content, while low engagement might indicate that the content is not capturing their attention.
E. Reading or Viewing Difficulty Level (321): This section assesses how difficult the audience finds it to read or view the content. It takes into account factors such as language complexity, visual clarity, and the pacing of audio or video content. This feedback helps creators ensure that their content is accessible to their target audience.
F. Clarity (323): This metric evaluates how clear and understandable the content is from the audience's perspective. If the content is confusing or ambiguous, this feedback will alert the creator to potential issues that need to be addressed.
G. Organization (324): This section assesses the overall structure and organization of the content. It evaluates whether the content is logically organized, whether ideas flow smoothly, and whether the content is easy to follow.
H. Political Bias (325): This metric evaluates whether the content is perceived as having a political bias. This is especially important for content intended to be neutral or objective. If the content is perceived as biased, the creator can make adjustments to ensure a more balanced presentation.
I. Audience Consensus (323): This section shows the degree of agreement among the simulated audience regarding their interpretation of the content. High consensus suggests that the content is clear and unambiguous, while low consensus might indicate that the content is open to multiple interpretations.

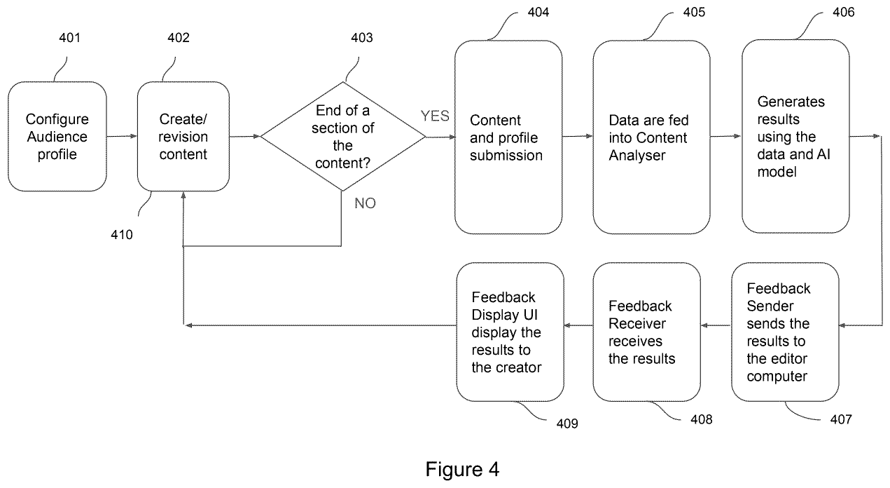

FIG. 4 is a functional flow diagram illustrating the interaction between various components of the system:
A. Audience Profile Configuration (401): The creator configures the audience profile by specifying the target audience's characteristics using the Audience Profile Specifier.
B. Content Creation (402): The creator begins by drafting or editing text, audio, or video content using the Content Editor.
C. Automatic submission timing (403): Depending on implementations, data can be sent to the simulation platform at any time as desired, e.g., whenever the content is changed, after a section is completed, or at the end of the whole content body. In this embodiment, we submit data whenever a section of the content is completed as an example.
D. Content and Profile Submission (404): The Content Sender and Audience Profile Sender transmit the content and audience profile data to the Audience Simulation Platform.
E. Feeding data into the AI engine (405): the Content Receiver and Audience Profile Receiver receive the data and feed them into Content Analyser.
F. AI Processing and Feedback Generation (406): The AI engine on the Audience Simulation Platform processes the content and simulates audience responses based on the specified profile. This includes interpreting the content, predicting expectations, assessing engagement and emotional response, and evaluating clarity, difficulty, and potential biases.
G. Feedback Transmission (407 and 408): The generated feedback is sent back to the creator's system via the Feedback Sender and Feedback Receiver.
H. Real-Time Feedback Display (409): The feedback is displayed to the creator through the Feedback Display UI, allowing for immediate insights and adjustments.
I. Content Revision (410): The creator uses the feedback to make revisions, improving the content's clarity, engagement, emotional impact, and alignment with audience expectations.
J. Iterative Refinement: The process is iterative, allowing the creator to continuously refine the content based on updated feedback until the desired quality is achieved.

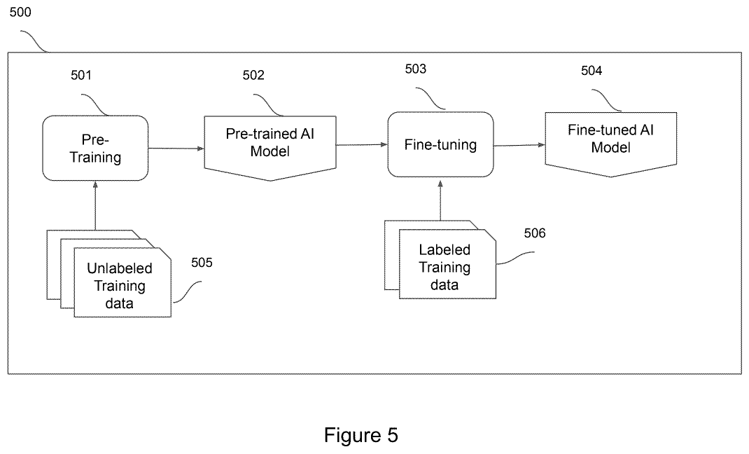

FIG. 5 shows an example of how to obtain a properly trained AI model used in the audience simulation platform. While the invention does not limit to a particular training method, this example illustrates the process to obtain the AI model that can serve our purpose. To support different audience profile specifications, a two-step training process is employed:
A. Pre-Training (501): In the first step, large amounts of unlabeled data (505), such as books, articles, and websites, are utilized. The goal during this phase is to capture, using an example of text content, the underlying patterns, structures, and semantic knowledge present within the text corpus. The outcome of this stage is a pre-trained model (502) capable of simulating general audiences but without specificity to particular profiles.
B. Fine-Tuning (503): The second step involves fine-tuning the model using labeled training data (506), such as data annotated with sentiment or other relevant attributes. This stage refines the AI model, resulting in a fine-tuned version (504) that can provide tailored feedback based on specific audience profiles provided alongside the content.

This two-step training approach ensures that the AI model is both broadly knowledgeable and finely attuned to the nuances of specific audience segments, making it capable of generating accurate and relevant simulated feedback.

### Conclusion

The disclosed embodiments are illustrative, not restrictive. While specific implementations have been described, it is understood that the present invention can be applied to a wide variety of systems. There are many alternative ways of implementing the invention.

What is claimed is:

1. A system for providing real-time feedback during the creation of content, comprising:
A content editor configured to allow a creator to draft and edit content in the form of text, audio, or video.
An audience profile specifier configured to allow the creator to define characteristics of a target audience.
A content sender and audience profile sender configured to transmit content and audience profile data to a remote simulation platform.
An audience simulation platform comprising an AI engine that processes the content and simulates audience feedback based on the specified profile.
A feedback receiver configured to receive simulated feedback from the audience simulation platform.
A feedback display UI configured to visually present the feedback to the creator in real-time.

2. The system of claim 1, wherein the audience simulation platform is further configured to:
Generate predicted audience interpretations, expectations, emotional responses, and engagement levels based on the content.
Provide feedback on the clarity, organization, difficulty level, and potential biases present in the content.

3. The system of claim 1, wherein the audience profile specifier allows the creator to specify audience characteristics including but not limited to gender, age, race, education level, occupation, industry, years of experience, location, ideology, religion, and cultural background.

4. The system of claim 2, wherein the feedback display UI includes metrics for predicted audience interpretation, audience expectations, emotional response, engagement level, clarity, organization, difficulty level, and political bias.

5. The system of claim 1, wherein the AI engine on the audience simulation platform continuously learns and updates its models based on new data to improve the accuracy of simulated audience feedback.
